(19) United States
(12) Patent Application Publication
(10) Pub. No.: US 2011/0166916 A1
(43) Pub. Date: Jul. 7, 2011

(54) Time-Resolved & User-Spatially-Activated Feedback Entrance and Method Thereof

(75) Inventor: Shay Inbar, Tel Aviv (IL)

(73) Assignee: ADS CAPTCHA LTD., Tel Aviv (IL)

(21) Appl. No.: 12/996,655

(22) PCT Filed: Jun. 14, 2009
(86) PCT No.: PCT/IL09/00589

§ 371 Date: Dec. 7, 2010

Related U.S. Application Data
(60) Provisional application No. 61/060,845, filed on Jun. 12, 2008.

(51) Int. Cl. G06F 3/048; G06Q 30/00

(52) U.S. Cl. 705/14.4; 715/862; 715/788

(57) ABSTRACT

The present invention discloses a time-resolved & user-spatially-activated feedback entrance (TruSafe) graphical user interface (GUI), useful to distinguish between allowed human feedback (entrance-OPENED) and disallowed response generated by a computer (entrance-LOCKED). The TruSafe comprises (i) a cursor operable by a human and (ii) at least one cursor sensitive zone (CSZ). The cursor and the CSZ are adapted to interact according to human perceptive response over time and space, and thus transform said TruSafe from its initial entrance-LOCKED configuration to at least one different terminal entrance-OPENED configuration. The TruSafe is useful for advertisement of goods and services. The invention also presents methods for securing an entrance-OPENED configuration, and advertising an advertisement by means of a TruSafe.

### FIELD OF THE INVENTION

The present invention pertains to computer-embedded time-resolved & user-spatially-activated feedback entrance (TruSafe), advertisement of goods and services by the same, and to methods thereof.

### BACKGROUND OF THE INVENTION

“Completely Automated Public Turing test to tell Computers and Humans Apart, (CAPTCHA™) is a type of challenge-response test used in computing to determine that the response is not generated by a computer, and especially not by internet robots (bots). The process involves one computer (a server) asking a user to complete a simple test which the computer is able to generate and grade. Because other computers are unable to solve the CAPTCHA, any user entering a correct solution is presumed to be human user. A set of patent applications were filed by Yahoo! Inc., including System and method for providing semantic captchas for online advertising, US20080133347A1; System and method for delivering online advertisements using captchas, US20080133348A1; and System and method for measuring awareness of online advertising using captchas, US20080133321A1. The general scope of those three inventions is a system and a method for using captchas for online advertising, specifically by storing a question about the advertisement along with a valid answer for use in verifying a user has received an impression of the advertisement. Those disclosers define a computer system for online advertising. The system comprises a CAPTCHA selector for selecting a CAPTCHA with an embedded advertisement for display as part of a web page. Those inventions utilize static CAPTCHAs, namely motionless, stationary and unchanging graphics including an image of one or more words that are distorted in order to make it difficult for an automated agent or machine process to decipher, but easy for a human to decipher.

A non-static mechanism adapted to distinguish between allowed human feedback and disallowed response generated by a computer is still a long-felt need. Means and methods for advertising brands by the said mechanism are not disclosed in the art. Moreover, enjoyable means and barrier-eliminating methods for facilitating or triggering the recall of a brand memory, increasing the identifiability of said brand, associating it to a positive experience or expectation, thus choosing said brand more often than other competing brands, is still an unmet need.

### BRIEF DESCRIPTION OF THE FIGURES

In order to understand the invention and to see how it may be implemented in practice, a plurality of embodiments is adapted to now be described, by way of non-limiting example only, with reference to the accompanying drawings, in which

FIG. 1 is a schematic view of a safe-type TruSafe (101) according to one embodiment of the invention;

FIG. 2 is a schematic view of game machine TruSafe (102) according to another embodiment of the invention;

FIG. 3 is a schematic view of manually operated gambling machine-type TruSafe (103) according to another embodiment of the invention; and,

FIG. 4 is a schematic view of a puzzle (here, a multi-dial array) TruSafe (104) according to another embodiment of the invention;

### SUMMARY OF THE INVENTION

The present invention discloses a time-resolved & user-spatially-activated feedback entrance (TruSafe) graphical user interface (GUI), useful to distinguish between allowed human feedback (entrance-OPENED) and disallowed response generated by a computer (entrance-LOCKED), The TruSafe inter alia comprises (i) a cursor operable by a human and (ii) at least one cursor-sensitive zone (CSZ). The cursor and the CSZ are adapted to interact according to human perceptive response over time and space, and thus transform the TruSafe from its initial entrance-LOCKED configuration to at least one different terminal entrance-OPENED configuration.

The present invention also discloses a TruSafe as defined above, wherein the CSZ comprises a plurality or array of cursor-rearrangeable, cursor-selectable or cursor-movable symbols transformable from an initial entrance-LOCKED symbol configuration to at least one terminal entrance-OPENED symbol configuration.

The present invention also discloses a TruSafe as defined above adapted useful for displaying advertisements. The initial entrance-LOCKED symbol configuration; at least one terminal entrance-OPENED symbol configuration or intermediates thereof provide an advertisement.

The present invention also discloses a TruSafe as defined above, wherein the interaction over space of the CSZ, the cursor or portions thereof are rotatable; translocatable in either planar 2D or spatial 3D; magnifiable (zooming in) or miniaturable (zooming out); either 2D or 3D distortable; color, shade, transparency, focus and texture regulable; or any combination thereof.

The present invention also discloses a TruSafe as defined above, wherein the interaction is selected from a group consisting inter alia of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing or otherwise manipulating the cursor within the CSZ.

The present invention also discloses a TruSafe as defined above, wherein the TruSafe is characterized in that the GUI is a general representation of safe, the CSZ or portion thereof is a turnable dial manipulable by the cursor, such that by turning the dial in a predetermined sequence of steps, the initial entrance-LOCKED symbol configuration is transformed to at least one terminal entrance-OPENED symbol configuration.

The present invention also discloses a TruSafe as defined above, wherein the initial entrance-LOCKED, at least one terminal entrance-OPENED symbol configuration or intermediate thereof provides an advertisement.

The present invention also discloses a gaming machine-like TruSafe as defined above. This TruSafe is characterized by a GUI which is a general representation of one-armed bandit gaming (i.e., a slot-) machine, the CSZ or portion thereof is an actuator manipulable by the cursor, such that by manipulating the actuator, the initial entrance-LOCKED symbol configuration is transformed to at least one terminal entrance-OPENED symbol configuration. The present invention also discloses a gaming machine-like TruSafe as defined above, wherein the initial entrance-LOCKED, at least one terminal entrance-OPENED symbol configuration or intermediates thereof provides an advertisement.

The present invention also discloses a puzzle-like TruSafe as defined above, characterized by a GUI which is a general representation of a puzzle, the CSZ or portion thereof is an incomplete puzzle solvable by the cursor, such that by manipulating the actuator, the puzzle is solved, and initial entrance-LOCKED symbol configuration is transformed to at least one terminal entrance-OPENED symbol configuration. The initial entrance-LOCKED, at least one terminal entrance-OPENED symbol configuration, or intermediate thereof preferably provides an advertisement.

The present invention also discloses a TruSafe as defined above, wherein the cursor and the CSZ are adapted to interact according to human perceptive response over time and space, and thus transform the TruSafe from an initial entrance-OPENED configuration to at least one terminal entrance-LOCKED configuration.

The present invention also discloses a falling-block game (e.g., Tetris, BreakOut and the like) TruSafe as defined above, characterized by a GUI which is a general representation of a field, the CSZ or portion thereof is a field characterized by at least one first region and at least one second region; the at least one first region comprises a plurality of one or more symbols either reversibly or irreversibly, randomly or non-randomly displayed and/or actuated within the region towards a capture area; the at least one second region comprises a cursor activating at least one effecter, the effecter is adapted to capture the symbols in a predetermined allowed sequence such that at the time the allowed sequence is solved, a terminal entrance-OPENED symbol configuration is obtained. The terminal entrance-OPENED symbol configuration preferably provides an advertisement.

The present invention also discloses a targeting game (e.g., Duck Hunt or Doom) TruSafe as defined above, characterized by a GUI which is a general representation of a field, the CSZ or portion thereof is a field comprises a plurality of one or more symbols either reversibly or irreversibly, randomly or non-randomly displayed and/or actuated, e.g. at any speed, direction, dimension, trajectory, etc. within the region; and a cursor directly targeting & activating [upon a click] the symbols in a predetermined allowed sequence such that at the time the allowed sequence is solved, a terminal entrance-OPENED symbol configuration is obtained. The terminal entrance-OPENED symbol configuration preferably provides an advertisement.

The present invention also discloses a shooting game (e.g., Space Invaders and Centipede) TruSafe as defined above, characterized by a GUI which is a general representation of a field, the CSZ or portion thereof is a field comprises a plurality of one or more symbols either reversibly or irreversibly, randomly or non-randomly displayed and/or actuated (e.g., at any speed, direction, dimension, trajectory, etc.) within the region; and a cursor targeting the symbols in an indirect manner, namely by shooting projectiles (e.g., representation of bullets, beams, missiles, arrows, balls, stones, etc.), towards (e.g., upon a click) the symbols in a predetermined allowed sequence such that at the time the allowed sequence is solved, a terminal entrance-OPENED symbol configuration is obtained. The terminal entrance-OPENED symbol configuration preferably provides an advertisement.

The present invention also discloses a Pac-Man TruSafe (e.g., Pac-Man or Snake) TruSafe as defined above, characterized by a GUI which is a general representation of a maze [either labyrinth or a practically free space], the CSZ or portion thereof is a curser-activated effecter (e.g., a Pac-Man like animation); the maze comprises a plurality of symbols; whereupon an allowed sequence of symbols is contacted by the effecter, a terminal entrance-OPENED symbol configuration is obtained. The terminal entrance-OPENED symbol configuration preferably provides an advertisement.

The present invention also discloses a method for distinguishing between allowed human feedback (entrance-OPENED) and disallowed response generated by a computer (entrance-LOCKED). The method comprises steps of (a) obtaining at least one time-resolved & user-spatially-activated feedback entrance (TruSafe) graphical user interface (GUI); (b) providing the TruSafe with (i) a cursor operable by a human and (ii) at least one cursor-sensitive zone (CSZ); (c) interacting, according to human perceptive response over time and space, the cursor and the CSZ; and (c) transforming the TruSafe from its initial entrance-LOCKED configuration to at least one terminal entrance-OPENED configuration.

The method may further comprise steps of (i) providing the CSZ with a plurality or array of cursor-rearrangeable, cursor-selectable or cursor-movable symbols; and (ii) transforming the CSZ from an initial entrance-LOCKED symbol configuration to at least one terminal entrance-OPENED symbol configuration.

The method is provided useful for displaying advertisements. The step of transforming the TruSafe from its initial entrance-LOCKED configuration to at least one terminal entrance-OPENED configuration provides an advertisement.

The step of interacting over space and time of the CSZ, cursor or portions thereof may comprise sub-steps of rotating; trans-locating in either planar 2D or spatial 3D; magnifying (zooming in) or miniaturizing (zooming out); either 2D or 3D distortion; coloring; shading; making transparent; focusing; texturing or any combination thereof.

The step of interacting over space and time of the CSZ, cursor or portions thereof may comprise sub-steps selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing or otherwise manipulating the cursor within the CSZ.

The method may characterized by representing a GUI as a general representation of a safe; providing the CSZ or portion thereof with a turnable dial; manipulating the turnable dial by the cursor, such that by turning the dial, the initial entrance-LOCKED symbol configuration is transformed to at least one terminal entrance-OPENED symbol configuration.

The method may be useful for displaying advertisements; wherein the step of transforming the TruSafe from its initial entrance-LOCKED configuration to at least one terminal entrance-OPENED configuration provides an advertisement.

The present invention also discloses a method which is characterized by representing a GUI as a general representation of a slot gaming machine, providing the CSZ or portion thereof with an actuator manipulable by the cursor; manipulating the actuator, thereby transforming the initial entrance-LOCKED symbol configuration to at least one terminal entrance-OPENED symbol configuration.

The method may be useful for displaying advertisements; wherein the step of transforming the TruSafe from its initial entrance-LOCKED configuration to at least one terminal entrance-OPENED configuration provides an advertisement.

The present invention also discloses a method which is characterized by representing a GUI as a general representation of a puzzle, the CSZ or portion thereof as an incomplete puzzle solvable by the cursor; manipulating the actuator; solving the puzzle thereby transforming the initial entrance-LOCKED symbol configuration to at least one terminal entrance-OPENED symbol configuration.

The method may be useful for displaying advertisements; wherein the step of transforming the TruSafe from its initial entrance-LOCKED configuration to at least one terminal entrance-OPENED configuration provides an advertisement.

The present invention also discloses a method for (i) stimulating explicit (active conscious-) memory, i.e., facilitating or triggering the recall of a brand memory, and/or (ii) increasing implicit (passively inducement to select a brand-) memory i.e., better identifying the brand, associating it with a positive experience or expectation, thus choosing the brand more often than other competing brands; the method comprising: (a) obtaining at least one time-resolved & user-spatially-activated feedback entrance (TruSafe) graphical user interface (GUI); (b) providing the TruSafe with (i) a cursor operable by a human and (ii) at least one cursor sensitive zone (CSZ); (c) providing the CSZ with a plurality or array of cursor-rearrangeable, cursor-selectable or cursor-movable symbols; (d) interacting, according to human perceptive response over time and space, the cursor and the CSZ; and (e) transforming the CSZ from an initial entrance-LOCKED symbol configuration to at least one terminal entrance-OPENED symbol configuration. The step of transforming the TruSafe from its initial entrance-LOCKED configuration to at least one terminal entrance-OPENED configuration stimulates explicit memory and/or enhances implicit memory of the brand.

The method is also useful for stimulating explicit memory, and/or increasing implicit memory of a brand/messages; the method further comprising presenting the (step d) interacting as a rewarding challenge and the (step e) transforming as a solution; thereby emotionally satisfying the user. The method is also useful wherein the rewarding is enjoyable, and/or wherein the rewarding is money or otherwise valuable.

The present invention also discloses a method which is a TruSafe tailored, adapted to user specific characteristics, wherein the characteristics are selected from a group consisting of age, demographic, socioeconomic status, gender, ethnicity, religion, or any combination thereof.

The present invention also discloses a method useful for measuring the understanding, comprehension, internalization, apprehension, or psychological or neurological impact of a communicative message comprising steps of (step a) obtaining at least one time-resolved & user-spatially-activated feedback entrance (TruSafe) graphical user interface (GUI); (step b) providing said TruSafe with (i) a cursor operable by a human and (ii) at least one cursor sensitive zone (CSZ); (step c) interacting, according to human perceptive response over time and space, said cursor and said CSZ; (step d) transforming said TruSafe from its initial entrance-LOCKED configuration to at least one terminal entrance-OPENED configuration; step (e) measuring quantifiable properties of user response; (step f) analyzing said measurements by valid mathematical operations; and (step g) storing or outputting an output number or numbers; wherein said quantifiable properties of user response are selected from one or more of the list of response time, completion time, average speed of cursor movement, number of keystrokes, number of clicks, number of attempts, and any combination thereof; and said communicative message appears as part of or near said TruSafe before, after, or at any step of its operation.

The present invention also discloses a method useful for measuring the understanding, comprehension, internalization, apprehension, or psychological or neurological impact of a communicative message wherein said communicative message comprises an advertisement.

This invention also discloses a method useful for rewarding a party in relation to the understanding, comprehension, internalization, apprehension, or psychological or neurological impact of a communicative message, comprising steps of obtaining an output from the method for measuring that understanding, comprehension, internalization, apprehension, or psychological or neurological impact of that communicative message, relating the output number or numbers through a mathematical formula to a reward, and transferring said reward to one or more parties; wherein said reward comprises money, credits, or any denominable amount of value; said mathematical formula comprises any valid mathematical operation or operations; and wherein said reward is measured in any denomination of numerical value, including currency, credits, etc.

The present invention also discloses a method according wherein the an advertisement displayed as part of a TruSafe as defined above comprises an image, text, animation, or any other electronic visual form.

This invention also discloses a method wherein an image, text, animation, or other electronic visual form used as part of a TruSafe as defined above is transferred from a database or other source without requiring an action by the owner of the source image, text, animation, or other electronic form; i.e., said advertisement is transferred automatically or by the host of the TruSafe, but not the advertiser.

### DETAILED DESCRIPTION OF PREFERRED EMBODIMENTS

The following description is provided, alongside all chapters of the present invention, so as to enable any person skilled in the art to make use of the invention and sets forth the best modes contemplated by the inventor of carrying out this invention. Various modifications, however, are adapted to remain apparent to those skilled in the art, since the generic principles of the present invention have been defined specifically to provide computer embedded time-resolved & user-spatially-activated feedback entrance (TruSafe) and to methods thereof.

It is one object of the present invention to disclose a TruSafe graphical user interface (GUI), useful to distinguish between allowed human feedback (entrance-OPENED) and disallowed response generated by a computer (entrance-LOCKED).

In a narrow and specific aspect of the invention, TruSafe is a dynamic CAPTCHA wherein the term ‘dynamic’ refers to a two-dimensional (2D) or a three-dimensional (3D) configuration transformation (here, e.g., a change of a GUI-based item, such as CAPTCHA) over time. A dynamic CAPTCHA conceptually differs from a commercially available and static CAPTCHA known in the art. In such a static CAPTCHA, the configuration (location, orientation etc) of the GUI item is static, i.e., is not transformed and not changed during the time it is used. In most cases, preset symbols (-usually text) are added to a predefined location within the item.

The said planar or spatial transformation and planar/spatial change is associated with one or more of the following re-configuring actions of the TruSafe or portions thereof: e.g., rotating; trans-locating in either planar 2D or spatial 3D; magnifying (zooming in) or miniaturizing (zooming out); either 2D or 3D distorting; coloring; shading; making transparent; focusing and texturing or any combination thereof.

According to one embodiment of the invention, the TruSafe comprises (i) a cursor, operable by a human and (ii) at least one cursor sensitive zone (CSZ). The cursor and the CSZ are adapted to interact according to human perceptive response over time and space, and thus transform the TruSafe from its initial entrance-LOCKED configuration to at least one different terminal entrance-OPENED configuration.

It is in the scope of the invention wherein the cursor is any user-activated and computer-embedded effecter. The cursor is selected, in a non-limiting manner, from a group consisting of arrows, directors, indicators, hand-like figures, rectangular or curved planar or spatial icons, lines, textures, various items in use by man (such as, e.g., magnifying glass, working tools, hammers, forceps, arms, pistons, needles, levers, knobs, knives, dials etc.), figures, logos, fonts, symbols, notes, keys, drawings, clips, photos, animated signs, loop-like, pen, brushes etc. The cursor is activated and controlled by any suitable means, such as, e.g., a computer mouse, a joystick, a keyboard, a touch screen, a voice-based means, etc.

It is also in the scope of the invention wherein the at least one CSZ is any user-activated and computer-embedded effecter. The cursor is selected, in a non-limiting manner, from a group consisting of any articles of manufacture (e.g., safes, vaults, boxes, drawers, weapons, toys, etc), items in use by man and animals, games, game-tools, and items thereof, household items, domestic items, articles used in an office, laboratory, hospital and work, road and transportation-related items, working tools, sport-related items, entertainment and lifestyle-related items, furniture, items related to the human habitat and environment, etc.

The TruSafe, the CSZ and/or cursor are provided in any available manner, e.g., in full-process colors, grayscale colors, in detailed or in general and conceptual manner, in any texture and appearance, in a static 2D or 3D drawing, photo or animation, or a dynamic video or cartoon-like manner. The TruSafe, the CSZ, cursor and/or interaction thereof may be further incorporated with music, voice or otherwise audio content.

It is also in the scope of the invention wherein the cursor and the CSZ are adapted to interact. The terms ‘interact’ and ‘interaction’ interchangeably refer hereinafter, in a non-limiting manner, to a two-dimensional (2D) or a three-dimensional (3D) configuration transformation of the CSZ or portions thereof along the time of using the TruSafe.

It is also in the scope of the invention wherein the interaction is provided by a human perceptive response over time and space. A user activates the cursor. The activation is provided by any suitable manner, e.g., by use of hands, voice, eye indications, etc. The activation is facilitated by conscious and willful human response. According to one preferred embodiment of the invention, a propioceptic (either 2D or 3D) human perceptive response, e.g., a eye-hand (computer mouse) propioceptic response.

The cursor and the CSZ are thus adapted to interact according to human perceptive response over time and space, and thus transform the TruSafe from its initial entrance-LOCKED configuration to at least one different terminal entrance-OPENED configuration.

It is still in the scope of the invention wherein the CSZ comprises a plurality or array of cursor-rearrangeable, cursor-selectable or cursor-movable symbols (e.g., notes, pictograms, text, data, letters, numbers, shaped-members, icons, images etc) transformable from an initial entrance-LOCKED symbol configuration to at least one terminal entrance-OPENED symbol configuration.

It is also in the scope of the invention wherein the TruSafe as defined in any of the above is used for displaying advertisements and brands. According to this embodiment of the invention, the initial entrance-LOCKED symbol configuration; at least one terminal entrance-OPENED symbol configuration or intermediates thereof provides an advertisement or a representation of a brand.

It is also in the scope of the invention wherein the interaction over space of the CSZ, cursor or portions thereof is one or more of the following: rotatable; translocable in either planar 2D or spatial 3D; magnifiable (zooming in) or miniaturable (zooming out); either 2D or 3D distortable; color, shade, transparency, focus and texture regulable; or any combination thereof.

It is also in the scope of the invention wherein the interaction as defined in any of the above is selected from a group consisting of e.g., virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing or otherwise manipulating the cursor within the CSZ.

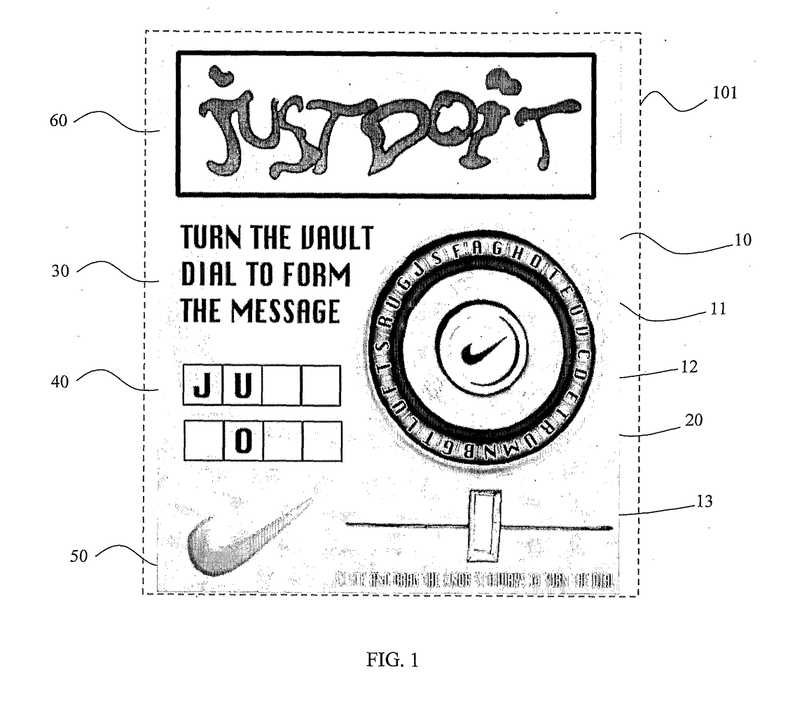

According to one specific embodiment of the invention, the TruSafe is characterized in that the GUI is a general representation of safe or other vault-like item. Reference is now made to FIG. 1, illustrating such a safe-like GUI (101). The safe-like GUI comprises various optional items, such as the following items, that will be described here in a non-limiting mariner: at least one CSZ, here, a safe dial 10; safe dial symbols (characters) 11; a safe dial knob 12; dial rotating lever 13; cursor 20; specifications, protocols, operation manuals, etc 30; windows and text cases 40; OCR-proof text 60; logos and other advertisements 50; and so on and so forth. In this embodiment, CSZ 10 or portions thereof (e.g., items 11 and/or 12) are a turnable dial 12 manipulable by a cursor 20, such that by turning the dial, the initial entrance-LOCKED symbol configuration is transformed to at least one terminal entrance-OPENED symbol configuration. Here, an encoded or otherwise disrupted (OCR-immuned) advertising slogan is projected: ‘Just Do It’ 60. The user is instructed by manual 30 to turn the dial of the vault 10 or 11 to form message 60 or portions thereof. By transforming CSZ 10 by cursor 20, namely rotating the dial so as to allocate the symbols 11 in the preset sequence define in message 60, such that the CSZ configuration is rotatably twisted in the plane of the TruSafe GUI, from an initial entrance-LOCKED configuration, to a final terminal entrance-OPENED configuration, where the allocated and dynamically picked symbols are set in window 40 as the predefined sequence of symbols. It is still within an alternative scope of the invention wherein the advertising slogan (60) which is projected is not encoded or not otherwise disrupted (and thus not OCR-immuned).

It is well within the scope of the invention, wherein the text 60 is ‘twisted’ in a manner that any OCR algorithm can be defeated. In one embodiment of the invention, there is a predetermined correlation between the manner the text is twisted and the identity of advertiser, the brand, the slogan, the manning of the slogan or its appearance. Hence for example, the trademark Coca Cola is twisted to its commercially known calligraphic style. The distortion (twisting) of the symbols is provided in any useful manner, e.g., and in a non-limiting manner, by twisting the text, conjoining neighbor symbols, adding graphical textures and appendages, etc.

It is an object of the invention to disclose a TruSafe as defined above, wherein the initial entrance-LOCKED, at least one terminal entrance-OPENED symbol configuration or intermediates thereof provides an advertisement. Here, the resolved sequence of the symbols retrieves the slogan to be advertized.

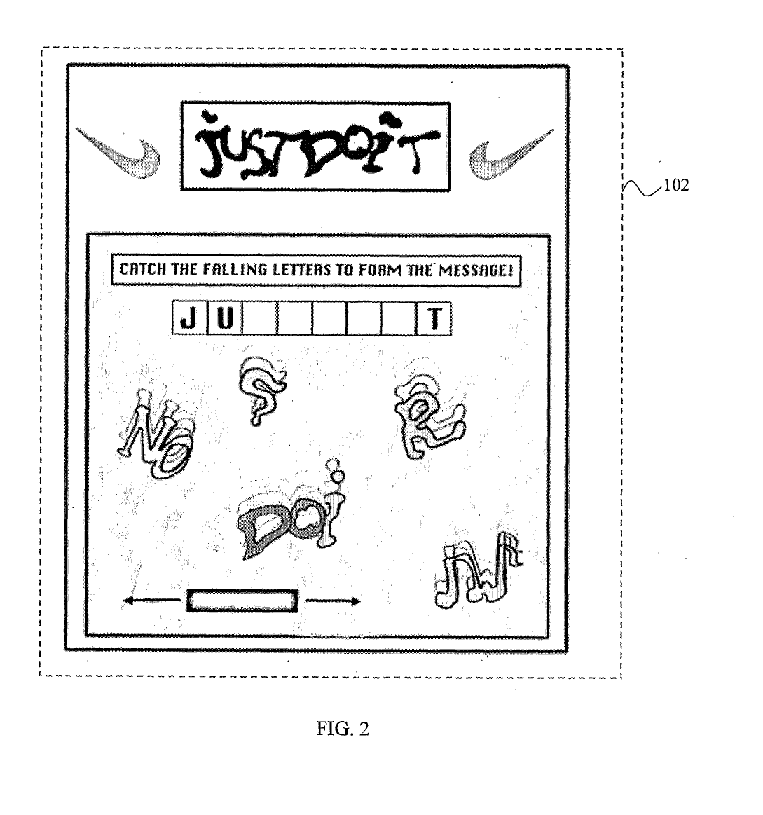

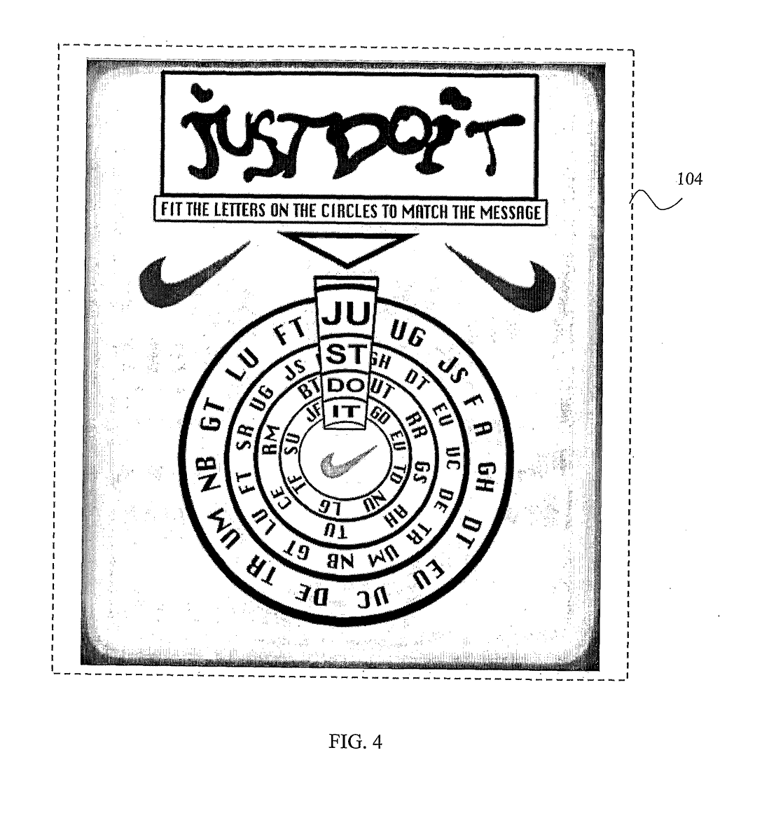

Reference is now made to FIGS. 2-4, illustrating a set of games (102-104), e.g., a puzzle-like game; a falling-block game (103), a shooting game, etc. For example, the TruSafe is characterized in that the GUI is a general representation of a puzzle, e.g., multiple concentric dials, jigsaw, Scrabble-like, Rubies Cube-like, interlocking bricks, either 2D or 3D puzzles, chess-like, checkers-like, backgammon-like, dice and dice-like, card games or any other commercially available games). The CSZ or portions thereof are an incomplete puzzle solvable by a cursor, such that by manipulating the actuator, the puzzle is solved, and an initial entrance-LOCKED symbol configuration is transformed to at least one terminal entrance-OPENED symbol configuration. It is in the scope of the invention wherein the initial entrance-LOCKED, at least one terminal entrance-OPENED symbol configuration or intermediates thereof provide an advertisement or brand name. The cursor and the one or more CSZs are adapted to interact according to human perceptive response over time and space, and thus transform the TruSafe from an initial entrance-OPENED configuration to at least one terminal entrance-LOCKED configuration.

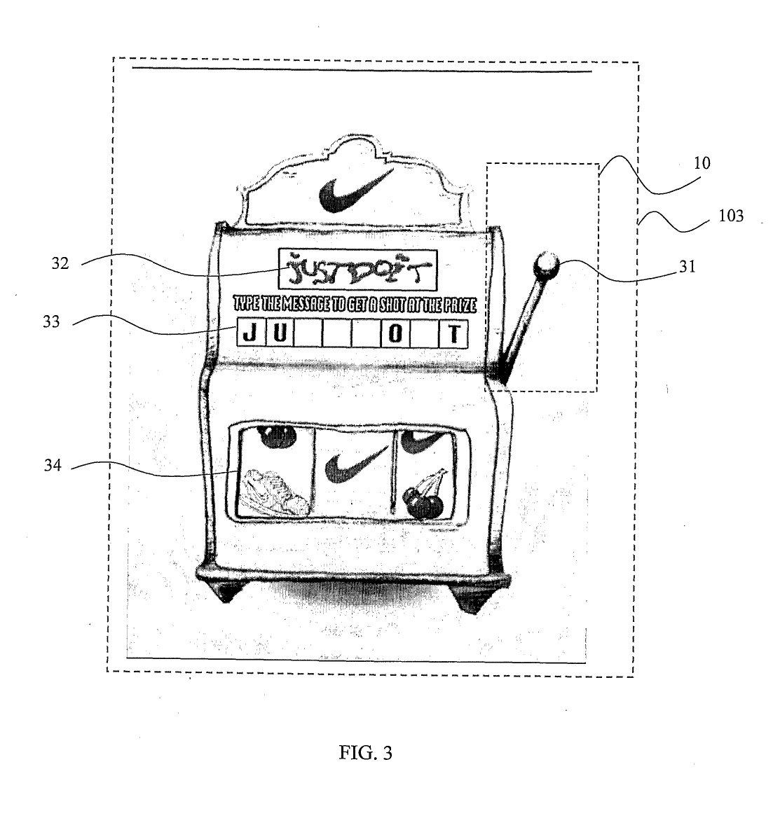

Reference is now made to FIG. 3, illustrating, in a general manner any gaming machine-like TruSafe 103 according another embodiment of the invention. The gaming machine-like TruSafe 103 is characterized in that the projected GUI is a general representation of slot machine (also known as a ‘one-armed bandit’). The CSZ or portion thereof is an actuator 31 (e.g., a lever, button etc) manipulable by the cursor, such that by manipulating the actuator, the initial entrance-LOCKED symbol configuration is transformed to at least one terminal entrance-OPENED symbol configuration. It is acknowledged in this respect that the initial entrance-LOCKED, at least one terminal entrance-OPENED symbol configuration or intermediate thereof 33 provides an advertisement or brand. More specifically, FIG. 3 comprises illustrates a slot machine containing various optional items, such as the following items, that will be described here in a non-limiting manner: warped text, 32; a text input display, 33; a spinning symbol field, 34; an actuable lever, 31. Said lever is within a CSZ, 10. The spinning field 34 initially displays an entrance-LOCKED symbol configuration. Warped text 32 can be read by a human but not an OCR algorithm. The user types the text, which appears in a text field 33. Then lever 31 is activated and the user clicks within CSZ 10 to activate the lever 31. The symbols in region 34 spin until a predetermined entrance-OPENED (not random, as in a real slot machine) appear. Alternatively, the user first clicks within CSZ 10 to activate the lever 31. Then, the symbols in field 34 spin until they reach one of many pre-determined configurations for which there is understood to be a “prize” associated (three of the same symbol, two of a significant symbol plus third, etc.). After this symbol configuration is reached, the user can type in the remaining characters to fill in field 33. The user is then granted entry to a website.

Another object of the invention is to disclose a method for distinguishing between allowed human feedback (entrance-OPENED) and disallowed response generated by a computer (entrance-LOCKED). The method comprises steps of: (a) obtaining at least one time-resolved & user-spatially-activated feedback entrance (TruSafe) graphical user interface (GUI); (b) providing the TruSafe with (i) a cursor operable by a human and (ii) at least one cursor sensitive zone (CSZ); (c) interacting, according to human perceptive response over time and space, the cursor and the CSZ; and (d) transforming the TruSafe from its initial entrance-LOCKED configuration to at least one terminal entrance-OPENED configuration.

It is in the scope of the invention wherein the method further comprises steps of (i) providing the CSZ with a plurality or array of cursor-rearrangeable, cursor-selectable or cursor-movable symbols; and (ii) transforming the CSZ from an initial entrance-LOCKED symbol configuration to at least one terminal entrance-OPENED symbol configuration. The method as defined above is provided useful for displaying advertisements. The step of transforming the TruSafe from its initial entrance-LOCKED configuration to at least one terminal entrance-OPENED configuration provides an advertisement. The step of interacting over space and time with the CSZ, cursor, or portions thereof comprises, according to yet another embodiment of the invention, possible sub-steps of rotating; trans-locating in either planar 2D or spatial 3D; magnifying (zooming in) or miniaturizing (zooming out); either 2D or 3D distortion; coloring; shading; making transparent; focusing and texturing or any combination thereof.

The step of interacting over space and time with the CSZ, cursor, or portions thereof comprises, according to yet another embodiment of the invention, sub-steps selected e.g., from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing or otherwise manipulating the cursor within the CSZ.

The method may be characterized, according to yet another embodiment of the invention, by representing a GUI as a general representation of a safe [a vault]; providing the CSZ or portion thereof with a turnable dial; manipulating the turnable dial by the cursor, such that by turning the dial, the initial entrance-LOCKED symbol configuration is transformed to at least one terminal entrance-OPENED symbol configuration. The method is hence provided useful for displaying advertisements, wherein the step of transforming of the TruSafe from its initial entrance-LOCKED configuration to at least one terminal entrance-OPENED configuration provides an advertisement or a brand name.

It is according to yet another embodiment of the invention, wherein the method is characterized by representing a GUI as a general representation of a slot machine, providing the CSZ or portion thereof with an actuator [e.g., a lever, a button etc] manipulable by the cursor; manipulating the actuator, thereby transforming the initial entrance-LOCKED symbol configuration to at least one terminal entrance-OPENED symbol configuration. The method is useful for displaying advertisements, wherein the step of transforming the TruSafe from its initial entrance-LOCKED configuration to at least one terminal entrance-OPENED configuration provides an advertisement.

It is according to yet another embodiment of the invention, wherein the method is characterized by representing a GUI as a general representation of a puzzle as defined above, wherein the CSZ or portions thereof are an incomplete puzzle solvable by the cursor; manipulating the actuator; solving the puzzle thereby transforming the initial entrance-LOCKED symbol configuration to at least one terminal entrance-OPENED symbol configuration. The method is provided useful for displaying advertisements; especially wherein the step of transforming the TruSafe from its initial entrance-LOCKED configuration to at least one terminal entrance-OPENED configuration provides an advertisement or a brand name.

It is another object of the invention to disclose a method for (i) stimulating explicit (active conscious-) memory, i.e., facilitating or triggering the recall of a brand memory, and/or (ii) increasing implicit (passive inducement to select a brand-) memory i.e., better identification of the brand, associating it with a positive experience or expectation, thus choosing the brand more often than other competing brands. This method of doing business comprises steps as follows: (a) obtaining at least one TruSafe GUI, e.g., as defined in any of the above; (b) providing the TruSafe with (i) a cursor operable by a human and (ii) at least one CSZ; (c) providing the CSZ with a plurality or array of cursor-rearrangeable, cursor-selectable or cursor-movable symbols as defined above; (d) manipulating, according to human perceptive response over time and space, the cursor within the CSZ; and (e) transforming the CSZ from an initial entrance-LOCKED symbol configuration to at least one terminal entrance-OPENED symbol configuration; wherein the step of transforming the TruSafe from its initial entrance-LOCKED configuration to at least one terminal entrance-OPENED configuration stimulating explicit memory and/or increasing implicit memory of the brand. It is well in the scope of the invention wherein this method further comprises a step or steps of presenting the interaction (step d) as a rewarding challenge and the transformation (step e) as a solution; thereby emotionally satisfying the user.

It is also in the scope of the invention, wherein parameters correlated with the computer-human activation are utilized to either measure or ensure advertising messages are internalized. Hence for example, a respectively rapid cursor operation, e.g., typing of symbols in an allowed sequence, indicating a high measure of message internalization, and vice versa, wherein a human is assumed to respond slower than a computer. Alternatively, accurate and/or rapid duck-like symbol-shooting indicates the same. Moreover, repeated use of the game-like TruSafe in an intelligent manner indicates a respectively high measure of enjoyment.

It is also in the scope of the invention, wherein pay-per-type (PPT) techniques are utilized, in which advertisers pay the TruSafe host or other party according to the number of keystrokes or amount of time a user spends completing the TruSafe. The fee or reward can be bid on or set a fixed amount. For example, whenever the TruSafe is activated or solved, the host, user, or any other party receives a predetermined fee from the advertiser. In addition, the reward may be correlated with the advertisement effectiveness, such as the exposure time or relative size of user exposure to the advertisement, the rapidity of the cursor movement, etc.

It is still in the scope of the invention wherein the aforesaid rewarding is enjoyable, e.g., fun, pleasurable for the user, etc. It is also in the scope of the invention wherein the aforesaid reward is provided by money or otherwise valuable asset: e.g., a credit, a coupon, a pass, a lottery ticket, a discount, goods, services, or other benefit to the user.

It is also in the scope of the invention wherein the TruSafe as defined in any of the above is tailored to fit user-specific characteristics, selected e.g., from a group consisting of age, demographic, socioeconomic status, gender, ethnicity, religion, or any combination thereof.

It is also within the scope of this invention to measure the understanding, comprehension, internalization, apprehension, or psychological or neurological impact of a communicative message comprising steps of (step a) obtaining at least one time-resolved & user-spatially-activated feedback entrance (TruSafe) graphical user interface (GUI); (step b) providing said TruSafe with (i) a cursor operable by a human and (ii) at least one cursor sensitive zone (CSZ); (step c) interacting, according to human perceptive response over time and space, said cursor and said CSZ; (step d) transforming said TruSafe from its initial entrance-LOCKED configuration to at least one terminal entrance-OPENED configuration; step (e) measuring quantifiable properties of user response; (step f) analyzing said measurements by valid mathematical operations; and (step g) storing or outputting an output number or numbers; wherein said quantifiable properties of user response are selected from one or more of the list of response time, completion time, average speed of cursor movement, number of keystrokes, number of clicks, number of attempts, and any combination thereof; and said communicative message appears as part of or near said TruSafe before, after, or at any step of its operation. The present invention also discloses a method useful for measuring the understanding, comprehension, internalization, apprehension, or psychological or neurological impact of a communicative message, wherein said communicative message comprises an advertisement. This invention also discloses a method useful for rewarding a party in relation to the understanding, comprehension, internalization, apprehension, or psychological or neurological impact of a communicative message, comprising steps of obtaining an output from the method for measuring that understanding, comprehension, internalization, apprehension, or psychological or neurological impact of that communicative message, relating the output number or numbers through a mathematical formula to a reward, and transferring said reward to one or more parties; wherein said reward comprises money, credits, or any denominable amount of value; said mathematical formula comprises any valid mathematical operation or operations; and wherein said reward is measured in any denomination of numerical value, including currency, credits, etc.

It is also within the scope of this invention wherein the advertisement is displayed as part of a TruSafe as defined above comprising an image, text, animation, or any other electronic visual form.

It is also within the scope of this invention wherein an image, text, animation, or other electronic visual form used as part of a TruSafe as defined above is transferred from a database or other source without requiring an action by the owner of the source image, text, animation, or other electronic form; i.e., said advertisement is transferred automatically or by the host of the TruSafe, but not the advertiser.

It is also within the scope of this invention wherein the TruSafe is characterized by a retrievable identification (ID), such as ID number, in which, according to some embodiments of the invention, the specified ID is further characterized with means selected from a group consisting of authentication means (namely, establishing or confirming, something (or someone) as authentic, that is, that claims made by or about the subject are true, and more specifically, a means that ensure the ID is well connected with the identity of the user); authoritification means (i.e., means which ensure the specific ID may enter the gate via the TruSafe); certification means, namely mean that refers to the confirmation of certain characteristics of an object, person, or organization; credit providing means (creditification), i.e., means which ensure payment per click etc; specification means, such as means adapted to provide specific ID (with specific authoritification, certification, creditfication, authentication). Hence, it is in the scope of the invention wherein an identified TruSafe is used to switch to one of its terminal entrance-OPENED configurations; and then, in a preset protocol, the introduction of the truSafe-ID allows the user to enter the gate. A database may store ID-TruSafe/ID-User/paremeters as defined above, and allow, according to said preset protocol, a user having an ID-TruSafe GUI to enter the gate.

1-52. (canceled)

53. A time-resolved & user-spatially-activated feedback entrance (TruSafe) graphical user interface (GUI), useful to distinguish between allowed human feedback (entrance-OPENED) and disallowed response generated by a computer (entrance-LOCKED); comprising (i) a cursor operable by a human and (ii) at least one cursor sensitive zone (CSZ); wherein said cursor and said CSZ are adapted to interact according to human perceptive response over time and space, and thus transform said TruSafe from its initial entrance-LOCKED configuration to at least one different terminal entrance-OPENED configuration.

54. The TruSafe according to claim 53; wherein said CSZ comprises a plurality or array of cursor-rearrangeable, cursor-selectable or cursor-movable symbols transformable from an initial entrance-LOCKED symbol configuration to at least one terminal entrance-OPENED symbol configuration.

55. The TruSafe according to claim 54, useful for displaying advertisements; wherein said initial entrance-LOCKED symbol configuration, at least one terminal entrance-OPENED symbol configuration, or intermediates thereof provide an advertisement.

56. The TruSafe according to claim 53, wherein said interaction over space of said CSZ, cursor or portions thereof are rotatable; translocatable in either planar 2D or spatial 3D; magnifiable (zooming in) or miniaturable (zooming out); either 2D or 3D distortable; color, shade, transparency, focus and texture regulable; or any combination thereof; further wherein said interaction is selected from a group consisting of virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing and otherwise manipulating said cursor within said CSZ.

57. The TruSafe according to claim 54, characterized in that said GUI is a general representation of a safe, said CSZ or portion thereof is a turnable dial manipulable by said cursor, such that by turning said dial in a predetermined sequence of steps, said initial entrance-LOCKED symbol configuration is transformed to at least one terminal entrance-OPENED symbol configuration; further wherein said initial entrance-LOCKED, at least one terminal entrance-OPENED symbol configuration or intermediates thereof, provides an advertisement.

58. A gaming machine-like TruSafe according to claim 54, characterized in that said GUI is a general representation of a slot machine (‘one-armed bandit’), said CSZ or portion thereof is an actuator manipulable by said cursor, such that by manipulating said actuator, said initial entrance-LOCKED symbol configuration is transformed to at least one terminal entrance-OPENED symbol configuration; further wherein said initial entrance-LOCKED, at least one terminal entrance-OPENED symbol configuration, or intermediates thereof provide an advertisement.

59. A puzzle-like TruSafe according to claim 54, characterized in that said GUI is a general representation of a puzzle, said CSZ or portion thereof is an incomplete puzzle solvable by said cursor, such that by manipulating an actuator, said puzzle is solved, and initial entrance-LOCKED symbol configuration is transformed to at least one terminal entrance-OPENED symbol configuration; further wherein said initial entrance-LOCKED, at least one terminal entrance-OPENED symbol configuration, or intermediates thereof provides an advertisement.

60. The TruSafe according to claim 53, wherein said cursor and said CSZ are adapted to interact according to human perceptive response over time and space, and thus transform said TruSafe from an initial entrance-OPENED configuration to at least one terminal entrance-LOCKED configuration.

61. A falling-block game TruSafe according to claim 54, characterized in that said GUI is a general representation of a field, said CSZ or portion thereof is a field characterized by at least one first region and at least one second region; wherein said at least one first region comprises a plurality of one or more symbols either reversibly or irreversibly, randomly or non-randomly displayed and/or actuated within said region towards a capture area; said at least one second region comprising a cursor activating at least one effecter, said effecter is adapted to capture said symbols in a predetermined allowed sequence such that at the time said allowed sequence is solved, a terminal entrance-OPENED symbol configuration is obtained; further wherein terminal entrance-OPENED symbol configuration provides an advertisement.

62. A targeting-game TruSafe according to claim 54, characterized in that said GUI is a general representation of a filed, said CSZ or portion thereof is a field comprises a plurality of one or more symbols either reversibly or irreversibly, randomly or non-randomly displayed and/or actuated within said region; and a cursor directly targeting & activating said symbols in a predetermined allowed sequence such that at the time said allowed sequence is solved, a terminal entrance-OPENED symbol configuration is obtained; further wherein a terminal entrance-OPENED symbol configuration provides an advertisement.

63. A shooting-game TruSafe according to claim 54, characterized in that said GUI is a general representation of a filed, said CSZ or portion thereof is a field comprises a plurality of one or more symbols either reversibly or irreversibly, randomly or non-randomly displayed and/or actuated within said region; and a cursor targeting said symbols in an indirect manner, namely by shooting projectiles or beams towards said symbols in a predetermined allowed sequence such that at the time said allowed sequence is solved, a terminal entrance-OPENED symbol configuration is obtained; further wherein terminal entrance-OPENED symbol configuration provides an advertisement.

64. A Pac-Man type TruSafe according to claim 54, characterized in that said GUI is a general representation of a maze, said CSZ or portion thereof is a cursor-activated effecter; said maze comprising a plurality of symbols; wherein an allowed sequence of symbols is contacted by said effecter and a terminal entrance-OPENED symbol configuration is obtained; further wherein a terminal entrance-OPENED symbol configuration provides an advertisement.

65. A “find the differences” type TruSafe according to claim 54, characterized in that said GUI comprises a plurality of two or more images, one or more cursor sensitive zones or portions thereof corresponding to regions in one or more pictures; wherein a correct identification of the regions that represent differences between two or more of the images results in a terminal entrance-OPENED symbol configuration; further wherein one or more of the images provides an advertisement.

66. A method for distinguishing between allowed human feedback (entrance-OPENED) and disallowed response generated by a computer (entrance-LOCKED); said method comprising steps of:
a. obtaining at least one time-resolved & user-spatially-activated feedback entrance (TruSafe) graphical user interface (GUI);
b. providing said TruSafe with (i) a cursor operable by a human and (ii) at least one cursor sensitive zone (CSZ);
c. interacting, according to human perceptive response over time and space, said cursor and said CSZ; and
d. transforming said TruSafe from its initial entrance-LOCKED configuration to at least one terminal entrance-OPENED configuration;
wherein said method is useful for displaying advertisements; further wherein said step of transforming said TruSafe from its initial entrance-LOCKED configuration to at least one terminal entrance-OPENED configuration provides an advertisement.

67. The method of claim 66; wherein said method further comprises steps of (i) providing said CSZ with a plurality or array of cursor-rearrangeable, cursor-selectable or cursor-movable symbols; and (ii) transforming said CSZ from an initial entrance-LOCKED symbol configuration to at least one terminal entrance-OPENED symbol configuration.

68. The method of claim 66, wherein said step of interacting over space and time with said CSZ, cursor or portions thereof comprises sub-steps selected from a group consisting of rotating; trans-locating in either planar 2D or spatial 3D; magnifying (zooming in) or miniaturizing (zooming out); either 2D or 3D distorting; coloring; shading; making transparent; focusing and texturing, virtual pressing, sustaining, leveraging, pulling, pushing, opening, closing, capturing, grasping, sliding, rolling, turning, coding, decoding, emitting sounds or vibrations, locking, unlocking, switching, drawing a pattern, scratching, rubbing, shooting, stubbing, piercing, pinning, indicating, typing, directing or otherwise manipulating said cursor within said CSZ or any combination thereof.

69. The method of claim 66, characterized by at least one selected from a group consisting of (a) representing a GUI as a general representation of a safe; providing said CSZ or portion thereof with a turnable dial; manipulating said turnable dial by said cursor, such that by turning said dial, said initial entrance-LOCKED symbol configuration is transformed to at least one terminal entrance-OPENED symbol configuration; (b) a GUI as a general representation of an slot machine, providing said CSZ or portion thereof with an actuator manipulable by said cursor; manipulating said actuator, thereby transforming said initial entrance-LOCKED symbol configuration to at least one terminal entrance-OPENED symbol configuration; (c) a GUI as a general representation of a puzzle wherein said CSZ or portion thereof is an incomplete puzzle solvable by said cursor; manipulating said actuator; solving said puzzle thereby transforming said initial entrance-LOCKED symbol configuration to at least one terminal entrance-OPENED symbol configuration; or any combination thereof.

70. The method of claim 69, wherein said cursor and said CSZ are adapted to interact according to human perceptive response over time and space, and thus transform said TruSafe from an initial entrance-OPENED configuration to at least one terminal entrance-LOCKED configuration.

71. The method of claim 70, characterized by at least one selected from a group consisting of (a) falling-block game TruSafe, wherein said GUI is a general representation of a field and said CSZ or portion thereof is a field characterized by at least one first region and at least one second region; wherein said at least one first region comprises a plurality of one or more symbols either reversibly or irreversibly, randomly or non-randomly displayed and/or actuated within said region towards a capture area; said at least one second region comprising a cursor activating at least one effecter, said effecter is adapted to capture said symbols in a predetermined allowed sequence such that at the time said allowed sequence is solved, a terminal entrance-OPENED symbol configuration is obtained; (b) a targeting-game TruSafe wherein said GUI is a general representation of a field; said CSZ or portion thereof is a field comprising a plurality of one or more symbols either reversibly or irreversibly, randomly or non-randomly displayed and/or actuated within said region; and a cursor directly targeting & activating said symbols in a predetermined allowed sequence such that at the time said allowed sequence is solved, a terminal entrance-OPENED symbol configuration is obtained; (c) a shooting-game TruSafe wherein said GUI is a general representation of a field; said CSZ or portion thereof is a field comprising a plurality of one or more symbols either reversibly or irreversibly, randomly or non-randomly displayed and/or actuated within said region; and a cursor targeting said symbols in an indirect manner, namely by shooting projectiles or beams towards said symbols in a predetermined allowed sequence such that at the time said allowed sequence is solved, a terminal entrance-OPENED symbol configuration is obtained; or any combination thereof.

72. The method of claim 71, wherein said step of transforming said TruSafe from its initial entrance-LOCKED configuration to at least one terminal entrance-OPENED configuration provides an advertisement.

73. A method according to claim 66, wherein said GUI is a general representation of a maze, said CSZ or portion thereof is a cursor-activated effecter; said maze comprising a plurality of symbols; wherein an allowed sequence of symbols is contacted by said effecter and a terminal entrance-OPENED symbol configuration is obtained; further wherein said step of transforming said TruSafe from its initial entrance-LOCKED configuration to at least one terminal entrance-OPENED configuration provides an advertisement.

74. A method for (i) stimulating explicit (active conscious-) memory, i.e., facilitating or triggering the recall of a brand memory, and/or (ii) increasing implicit (passive inducement to select a brand-) memory i.e., better identifying said brand, associating it with a positive experience or expectation, thus choosing said brand more often than other competing brands; said method comprising:
a. obtaining at least one time-resolved & user-spatially-activated feedback entrance (TruSafe) graphical user interface (GUI);
b. providing said TruSafe with (i) a cursor operable by a human and (ii) at least one cursor sensitive zone (CSZ);
c. providing said CSZ with a plurality or array of cursor-rearrangeable, cursor-selectable or cursor-movable symbols;
d. promoting interaction, according to human perceptive response over time and space, of said cursor with said CSZ; and
e. transforming said CSZ from an initial entrance-LOCKED symbol configuration to at least one terminal entrance-OPENED symbol configuration;
wherein said step of transforming said TruSafe from its initial entrance-LOCKED configuration to at least one terminal entrance-OPENED configuration stimulates explicit memory and/or enhances implicit memory of said brand.

75. The method of claim 74 for stimulating explicit memory, and/or enhancing implicit memory of a brand/messages; wherein said method further comprising at least one step selected from a group consisting of (a) presenting said (step d) interacting as a rewarding challenge said (step e) transforming as a solution; thereby emotionally satisfying the user; (b) selecting at least one user-specific characteristic from a group consisting of age, demographic, socioeconomic status, gender, ethnicity, religion, and any combination thereof.

76. The method of claim 74, wherein said rewarding is selected from a group consisting of enjoyable, money or otherwise valuable or any combination thereof.

77. A method useful for measuring the understanding, comprehension, internalization, apprehension, or psychological or neurological impact of a communicative message comprising steps of:
a. obtaining at least one time-resolved & user-spatially-activated feedback entrance (TruSafe) graphical user interface (GUI); providing said TruSafe with (i) a cursor operable by a human and (ii) at least one cursor sensitive zone (CSZ);
b. interacting, according to human perceptive response over time and space, said cursor and said CSZ;
c. transforming said TruSafe from its initial entrance-LOCKED configuration to at least one terminal entrance-OPENED configuration;
d. measuring quantifiable properties of user response;
e. analyzing said measurements by valid mathematical operations; and
f. storing or outputting an output number or numbers;
wherein said quantifiable properties of user response are selected from one or more of the list of response time, completion time, average speed of cursor movement, number of keystrokes, number of clicks, number of attempts, and any combination thereof; and
said communicative message appears as part of or near said TruSafe before, after, or at any step of its operation; further wherein said communicative message comprises an advertisement.

78. The method of claim 77, useful for rewarding a party for the understanding, comprehension, internalization, apprehension, or psychological or neurological impact of a communicative message, additionally comprising steps of:
a. Relating the output number or numbers through a mathematical formula to a reward; and
b. Transferring said reward to one or more parties;
wherein said reward comprises money, credits, or any denominable amount of value;
said mathematical formula comprises any valid mathematical operation or operations;
and wherein said reward is measured in any denomination of numerical value, including currency, credits.

79. The method according to claim 66, wherein the advertisement comprises an image, text, animation, or any other electronic visual form; further wherein said image, text, animation, or other electronic visual form is transferred from a database or other source without requiring an action by the owner of the source image, text, animation, or other electronic form; i.e., said advertisement is transferred to the TruSafe server automatically, by the host of the TruSafe, or any party other than the advertiser.
